(19) United States
(12) Patent Application Publication
(10) Pub. No.: US 2012/0226371 A1
(43) Pub. Date: Sep. 6, 2012

(54) MEMORY STORAGE APPARATUS, MEMORY CONTROLLER, AND AUDIO PLAYING METHOD

(75) Inventors: Chang-Hsueh Huang, Miaoli (TW); Chih-Yung Wu, Miaoli (TW); Yu-Ju Su, Miaoli (TW); Yuan-Pin Chang, Miaoli (TW)

(73) Assignee: PHISON ELECTRONICS CORP., Miaoli (TW)

(21) Appl. No.: 13/101,159

(22) Filed: May 5, 2011

(30) Foreign Application Priority Data
Mar. 4, 2011 (TW) 100107358

(51) Int. Cl. G06F 17/00; G06F 12/00

(52) U.S. Cl. 700/94; 711/154; 711/E12.001

(57) ABSTRACT

A memory storage apparatus and a memory controller and an audio playing method thereof are provided. The memory storage apparatus includes a connector, a rewritable non-volatile memory module, the memory controller, and an audio playing unit. The audio playing unit is coupled to the memory controller via at least one signal control pin and has a speaker and an audio control circuit. The memory controller transmits status information to the audio playing unit via the signal control pin. Besides, the audio control circuit decodes an audio file according the status information and controls the speaker to play the decoded audio file. Thereby, a user can be effectively alerted about the current status of the memory storage apparatus.

### CROSS-REFERENCE TO RELATED APPLICATION

This application claims the priority benefit of Taiwan application serial no. 100107358, filed Mar. 4, 2011. The entirety of the above-mentioned patent application is hereby incorporated by reference herein and made a part of this specification.

### BACKGROUND

1. Technology Field

The present invention generally relates to a memory storage apparatus, and more particularly, to a memory storage apparatus which can play an audio according to an access operation, and a memory controller and an audio playing method thereof.

2. Description of Related Art

Along with the widespread of digital cameras, cell phones, and MP3 in recently years, the consumers' demand to storage media has increased drastically. Rewritable non-volatile memory is one of the most adaptable storage media to portable electronic products due to its many characteristics such as data non-volatility, low power consumption, small volume, non-mechanical structure, and fast access speed. For example, a pen driver is a memory storage apparatus which uses a flash memory as its storage medium. Thereby, the flash memory industry has become a very important part of the electronic industry in recent years.

A pen driver is connected to a host system via a plug-and-play transmission interface (for example, a universal serial bus (USB)). Thus, a user can conveniently transmit files between different host systems by using a pen driver. However, because a pen driver can be easily plugged into or unplugged from a host system, data stored in the pen driver may be lost due to an improper operation of the user. For example, if the user unplugs the pen driver from the host system when the host system is transmitting data into the pen driver or the control circuit of the pen driver is accessing the flash memory module in a background mode, data stored in the pen driver may be lost.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

Accordingly, the present invention is directed to a memory storage apparatus, a memory controller, and an audio playing method, wherein an audio is played to alert a user when a write command or a read command is executed.

According to an exemplary embodiment of the present invention, a memory storage apparatus including a connector, a rewritable non-volatile memory module, a memory controller, and an audio playing unit is provided. The memory controller is coupled to the connector and the rewritable non-volatile memory module. The audio playing unit is coupled to the memory controller via at least one signal control pin and has a speaker and an audio control circuit coupled to the speaker. The memory controller transmits a status information to the audio playing unit via the signal control pin. Besides, the audio control circuit decodes at least one audio file according to the status information and controls the speaker to play the decoded audio file.

According to an exemplary embodiment of the present invention, an audio playing method adaptable to a memory storage apparatus is provided, wherein the memory storage apparatus has a rewritable non-volatile memory module and a speaker. The audio playing method includes determining whether a status information is received. The audio playing method also includes, when the status information is received, loading an audio file according to the status information, decoding the audio file and controlling the speaker to play the decoded audio file.

According to an exemplary embodiment of the present invention, a memory controller for accessing a rewritable non-volatile memory module according to instructions of a host system is provided. The memory controller includes a memory interface, a host interface, and a memory management circuit. The memory interface is configured for coupling to the rewritable non-volatile memory module. The host interface is configured for coupling to the host system. The memory management circuit is coupled to the memory interface and the host interface. The memory management circuit transmits a status information via at least one signal control pin, wherein the status information allows an audio playing unit with a speaker to decode an audio file and control the speaker to play the decoded audio file.

As described above, a memory storage apparatus, a memory controller, and an audio playing method are provided in exemplary embodiments of the present invention, wherein an audio is played when a data writing or reading operation is performed. Thereby, a user can be alerted and won't unplug the memory storage apparatus from the host system when the memory storage apparatus is executing a write command or a read command, so that data stored in the memory storage apparatus can be prevented from being lost.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1A illustrates a host system and a memory storage apparatus according to an exemplary embodiment of the present invention.

FIG. 1B is a diagram illustrating a computer, an input/output (I/O) device, and a memory storage apparatus according to an exemplary embodiment of the present invention.

FIG. 1C is a diagram illustrating a host system and a memory storage apparatus according to another exemplary embodiment of the present invention.

FIG. 2 is a schematic block diagram of the memory storage apparatus in FIG. 1A.

FIG. 3 is a schematic block diagram of a memory controller according to an exemplary embodiment of the present invention.

FIG. 4 is a schematic block diagram of an audio playing unit according to an exemplary embodiment of the present invention.

FIG. 5 is a flowchart of an audio playing method according to an exemplary embodiment of the present invention.

FIG. 6 is a schematic block diagram of a memory storage apparatus according to another exemplary embodiment of the present invention.

FIG. 7 is a schematic block diagram of a memory storage apparatus according to another exemplary embodiment of the present invention.

### DESCRIPTION OF THE EMBODIMENTS

Reference will now be made in detail to the present preferred embodiments of the present invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally speaking, a memory storage apparatus (also referred to as a memory storage system) includes a non-volatile memory module and a controller (also referred to as a control circuit). A memory storage apparatus is usually used along with a host system so that the host system can write data into or read data from the memory storage apparatus.

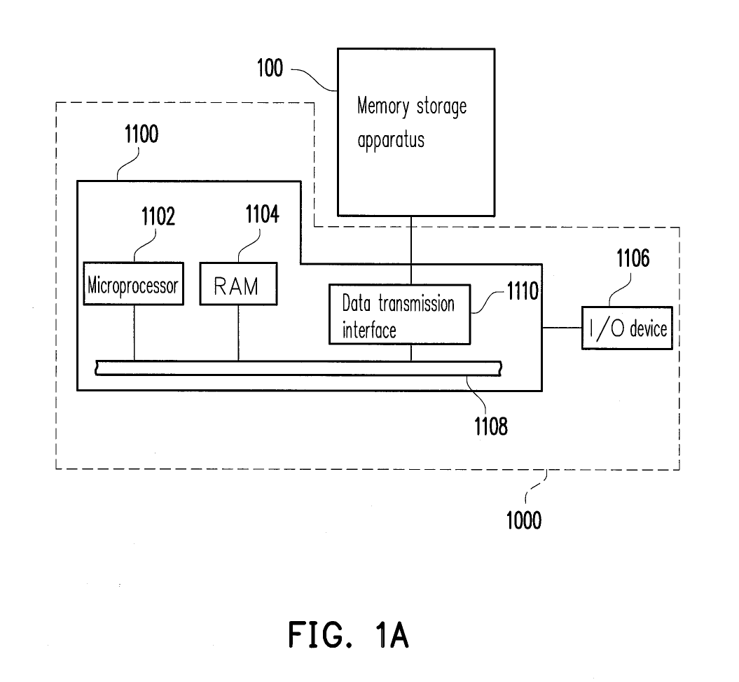

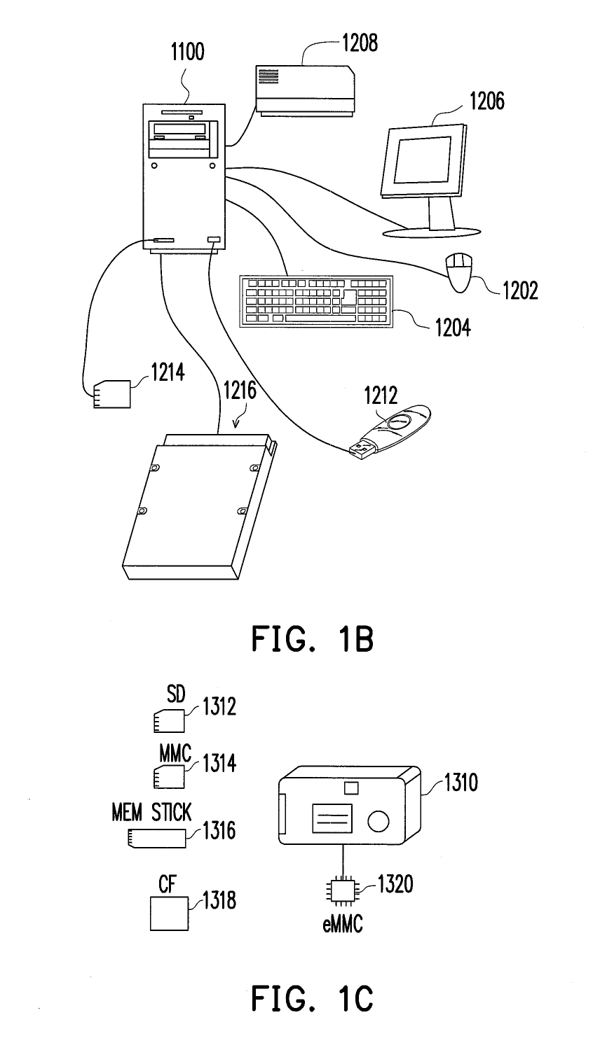

FIG. 1A illustrates a host system and a memory storage apparatus according to an exemplary embodiment of the present invention.

Referring to FIG. 1A, the host system 1000 includes a computer 1100 and an input/output (I/O) device 1106. The computer 1100 includes a microprocessor 1102, a random access memory (RAM) 1104, a system bus 1108, and a data transmission interface 1110. The I/O device 1106 includes a mouse 1202, a keyboard 1204, a display 1206, and a printer 1208, as shown in FIG. 1B. It should be understood that the I/O device 1106 is not limited to the devices illustrated in FIG. 1B and may further include other devices.

In the present embodiment, a memory storage apparatus 100 is coupled to other components of the host system 1000 through the data transmission interface 1110. Data can be written into or read from the memory storage apparatus 100 through the operations of the microprocessor 1102, the RAM 1104, and the I/O device 1106. The memory storage apparatus 100 may be a non-volatile memory storage apparatus, such as the pen driver 1212, the memory card 1214, or the solid state drive (SSD) 1216 illustrated in FIG. 1B.

Generally speaking, the host system 1000 may be substantially any system that can store data. Even though the host system 1000 is described as a computer system in the present exemplary embodiment, in another exemplary embodiment of the present invention, the host system 1000 may also be a digital camera, a video camera, a communication device, an audio player, or a video player. For example, if the host system is a digital camera (video camera) 1310, the memory storage apparatus is then a secure digital (SD) card 1312, a multi media card (MMC) 1314, a memory stick (MS) 1316, a compact flash (CF) card 1318, or an embedded storage apparatus 1320 (as shown in FIG. 1C) used by the digital camera (video camera) 1310. The embedded storage apparatus 1320 includes an embedded MMC (eMMC). It should be mentioned that an eMMC is directly coupled to the motherboard of the host system.

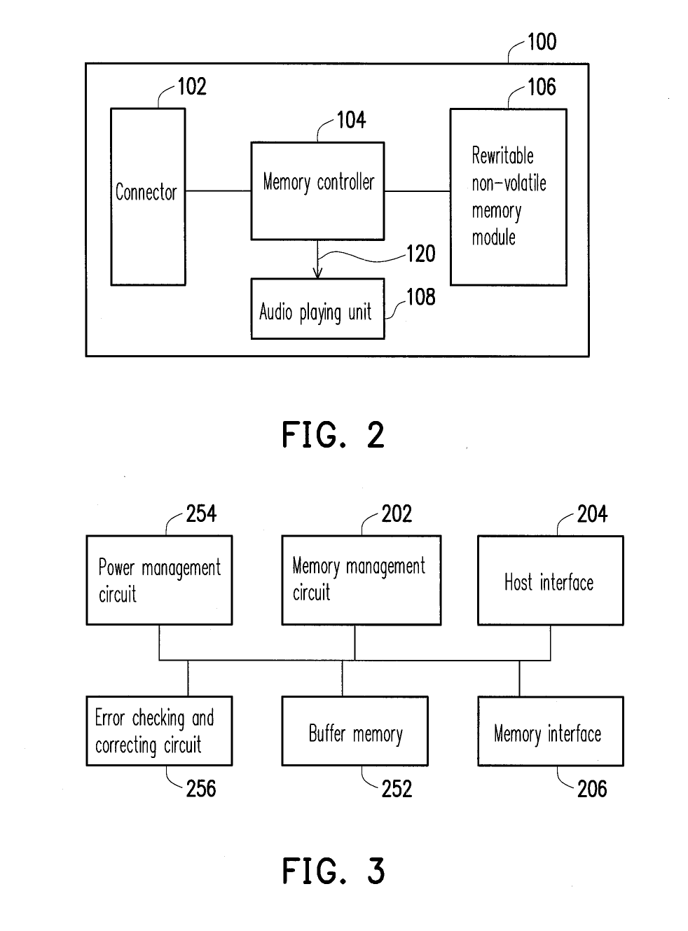

FIG. 2 is a schematic block diagram of the memory storage apparatus in FIG. 1A.

Referring to FIG. 2, the memory storage apparatus 100 includes a connector 102, a memory controller 104, a rewritable non-volatile memory module 106, and an audio playing unit 108.

In the present exemplary embodiment, the connector 102 is a universal serial bus (USB) connector. However, the present invention is not limited thereto, and the connector 102 may also be an Institute of Electrical and Electronic Engineers (IEEE) 1394 connector, a peripheral component interconnect (PCI) express connector, a serial advanced technology attachment (SATA) connector, a Parallel Advanced Technology Attachment (PATA) connector, a SD interface connector, a MS interface connector, a MMC interface connector, a CF interface connector, an integrated device electronics (IDE) connector, or any other suitable connector.

The memory controller 104 is coupled to the connector 102. The memory controller 104 executes a plurality of logic gates or control instructions implemented in a hardware form or a firmware form and performs various data operations on the rewritable non-volatile memory module 106 according to commands issued by the host system 1000.

FIG. 3 is a schematic block diagram of a memory controller according to an exemplary embodiment of the present invention.

Referring to FIG. 3, the memory controller 104 includes a memory management circuit 202, a host interface 204, and a memory interface 206.

The memory management circuit 202 controls the overall operation of the memory controller 104. To be specific, the memory management circuit 202 has a plurality of control instructions, and during the operation of the memory storage apparatus 100, the control instructions are executed to access the rewritable non-volatile memory module 106.

In the present exemplary embodiment, the control instructions of the memory management circuit 202 are implemented in a firmware form. For example, the memory management circuit 202 has a microprocessor unit (not shown) and a read-only memory (ROM, not shown), and the control instructions are burnt into the ROM. When the memory storage apparatus 100 is in operation the control instructions are executed by the microprocessor unit.

In another exemplary embodiment of the present invention, the control instructions of the memory management circuit 202 may also be stored in a specific area of the rewritable non-volatile memory module 106 (for example, the system area exclusively used for storing system data in a memory module) as program codes. In addition, the memory management circuit 202 has a microprocessor unit (not shown), a ROM (not shown), and a RAM (not shown). In particular, the ROM has a driving code, and when the memory controller 104 is enabled, the microprocessor unit first executes the driving code to load the control instructions from the rewritable non-volatile memory module 106 into the RAM of the memory management circuit 202. After that, the microprocessor unit runs these control instructions. Additionally, in yet another exemplary embodiment of the present invention, the control instructions of the memory management circuit 202 may also be implemented in a hardware form.

The host interface 204 is coupled to the memory management circuit 202 and configured for receiving and identifying commands and data sent by the host system 1000. Namely, commands and data sent by the host system 1000 are transmitted to the memory management circuit 202 via the host interface 204. In the present exemplary embodiment, the host interface 204 is, corresponding to the connector 102, a USB interface. However, it should be understood that the present invention is not limited thereto, and the host interface 204 may also be a PATA interface, an IEEE 1394 interface, a PCI express interface, a SATA interface, a SD interface, a MS interface, a MMC interface, a CF interface, an IDE interface, or any other suitable data transmission interface.

The memory interface 206 is coupled to the memory management circuit 202 and configured for accessing the rewritable non-volatile memory module 106. Namely, data to be written into the rewritable non-volatile memory module 106 is converted by the memory interface 206 into a format acceptable to the rewritable non-volatile memory module 106.

In an exemplary embodiment of the present invention, the memory controller 104 further includes a buffer memory 252. The buffer memory 252 is coupled to the memory management circuit 202 and configured for temporarily storing commands and data from the host system 1000 or data from the rewritable non-volatile memory module 106.

In an exemplary embodiment of the present invention, the memory controller 104 further includes a power management circuit 254. The power management circuit 254 is coupled to the memory management circuit 202 and configured for controlling the power supply of the memory storage apparatus 100.

In an exemplary embodiment of the present invention, the memory controller 104 further includes an error checking and correcting (ECC) circuit 256. The ECC circuit 256 is coupled to the memory management circuit 202 and configured for executing an ECC procedure to ensure data accuracy. To be specific, when the memory management circuit 202 receives a write command from the host system 1000, the ECC circuit 256 generates a corresponding ECC code for the data corresponding to the write command, and the memory management circuit 202 writes the data corresponding to the write command and the corresponding ECC code together into the rewritable non-volatile memory module 106. Subsequently, when the memory management circuit 202 reads data from the rewritable non-volatile memory module 106, it also reads the ECC code corresponding to the data, and the ECC circuit 256 executes the ECC procedure on the data according to the ECC code.

The rewritable non-volatile memory module 106 is coupled to the memory controller 104 and configured for storing data written by the host system 1000. In the present exemplary embodiment, the rewritable non-volatile memory module 106 is a rewritable non-volatile memory module. The rewritable non-volatile memory module 106 may be a multi level cell (MLC) NAND flash memory module. However, the present invention is not limited thereto, and the rewritable non-volatile memory module 106 may also be a single level cell (SLC) NAND flash memory module, another type of flash memory module, or another type of memory module having the same characteristics.

The audio playing unit 108 is coupled to the connector 102 and to the memory controller 104 via a signal control pin 120.

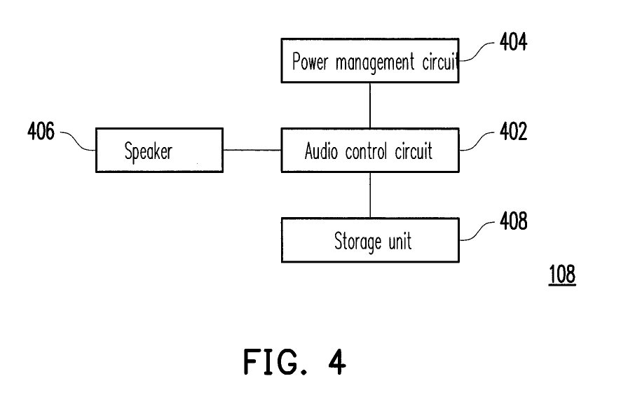

FIG. 4 is a schematic block diagram of an audio playing unit according to an exemplary embodiment of the present invention.

Referring to FIG. 4, the audio playing unit 108 includes an audio control circuit 402, a power management circuit 404, a speaker 406, and a storage unit 408.

The audio control circuit 402 is configured for controlling the overall operation of the audio playing unit 108.

The power management circuit 404 is coupled to the audio control circuit 402 and to a VCC pin and a GND pin of the connector 102. Besides, when the memory storage apparatus 100 is coupled to the host system 1000, the power management circuit 404 receives an input power from the connector 102 and supplies the operating voltage for the operation of the audio playing unit 108.

The speaker 406 is coupled to the audio control circuit 402 and configured for playing an audio under the control of the audio control circuit 402.

The storage unit 408 is coupled to the audio control circuit 402 and configured for storing an audio file. To be specific, the manufacturer of the memory storage apparatus 100 stores a predetermined audio file into the storage unit 408, and the audio control circuit 402 controls the speaker 406 to play the audio file stored in the storage unit 408. In the present exemplary embodiment, the audio file stored in the storage unit 408 may be a WAV file. In the present exemplary embodiment, the storage unit 408 is a ROM. However, the present invention is not limited thereto.

In the present exemplary embodiment, the memory management circuit 202 of the memory controller 104 transmits a status information via the signal control pin 120. Besides, when the audio playing unit 108 receives the status information via the signal control pin 120, the audio control circuit 402 identifies the status information, loads a corresponding audio file from the storage unit 408 according to the status information, decodes the audio file, and controls the speaker 406 to play the decoded audio file.

For example, when the memory storage apparatus 100 is coupled to the host system 1000, the memory management circuit 202 transmits an initial coupling status information via the signal control pin 120. When the memory management circuit 202 reads data from the rewritable non-volatile memory module 106, the memory management circuit 202 transmits a read status information via the signal control pin 120. When the memory management circuit 202 writes data into the rewritable non-volatile memory module 106, the memory management circuit 202 transmits a write status information via the signal control pin 120. When the memory management circuit 202 determines that the rewritable non-volatile memory module 106 is in a good status, the memory management circuit 202 transmits a good status information via the signal control pin 120. When the memory management circuit 202 determines that the rewritable non-volatile memory module 106 is in a bad status, the memory management circuit 202 transmits a bad status information via the signal control pin 120.

In the present exemplary embodiment, the size of the status information is one byte, wherein the first bit and the eighth bit are used for indicating the start and end of the status information, and the second to the seventh bits are used for indicating different status information.

For example, “10000011” represents an initial coupling status information, “10000101” represents a read status information, “10000111” represents a write status information, “10001001” represents a rewritable non-volatile memory module good status information, and “10001011” represents a rewritable non-volatile memory module bad status information. However, foregoing encoding is only an example but not intended to limit the present invention. In another exemplary embodiment of the present invention, the status information may also be represented by a string of any other size.

Additionally, the storage unit 408 stores at least one audio file corresponding to the initial coupling status information, at least one audio file corresponding to the read status information, at least one audio file corresponding to the write status information, at least one audio file corresponding to the rewritable non-volatile memory module good status information, and at least one audio file corresponding to the rewritable non-volatile memory module bad status information. Besides, when the audio playing unit 108 receives the coupling status information via the signal control pin 120 and identifies the same, the audio control circuit 402 decodes the audio file corresponding to the coupling status information and plays the decoded audio file. Similarly, when the audio playing unit 108 receives the read status information via the signal control pin 120 and identifies the same, the audio control circuit 402 decodes the audio file corresponding to the read status information and plays the decoded audio file. When the audio playing unit 108 receives the write status information via the signal control pin 120 and identifies the same, the audio control circuit 402 decodes the audio file corresponding to the write status information and plays the decoded audio file. When the audio playing unit 108 receives the rewritable non-volatile memory module good status information via the signal control pin 120 and identifies the same, the audio control circuit 402 decodes the audio file corresponding to the rewritable non-volatile memory module good status information and plays the decoded audio file. When the audio playing unit 108 receives the rewritable non-volatile memory module bad status information via the signal control pin 120 and identifies the same, the audio control circuit 402 decodes the audio file corresponding to the rewritable non-volatile memory module bad status information and plays the decoded audio file.

It should be mentioned that when multiple audio files are corresponding to a specific status information, the audio control circuit 402 may repeatedly play a specific audio file or play all these audio files in turn.

For example, when the memory management circuit 202 of the memory controller 104 writes data into or reads data from the rewritable non-volatile memory module 106, the speaker 406 may continuously play the ignition sound of a car engine.

Additionally, the memory management circuit 202 of the memory controller 104 transmits a stop signal via the signal control pin 120, and when the audio playing unit 108 receives the stop signal, the audio control circuit 402 controls the speaker 406 to stop playing the decoded audio file. For example, when a write or read operation is completed, the audio control circuit 402 controls the speaker 406 to stop playing the decoded audio file according to the stop signal received from the memory management circuit 202.

In the present exemplary embodiment, the audio file is stored in the storage unit 408. However, in another exemplary embodiment of the present invention, the audio file may also be stored in the rewritable non-volatile memory module 106 so that the storage unit 408 can be omitted.

The rewritable non-volatile memory module 106 has a plurality of physical blocks, and the physical blocks are grouped into a data area, a spare area, a system area, and a replacement area. In particular, the audio file may be stored in a physical block in the system area, and the audio playing unit 108 may loads the audio file from the system area of the rewritable non-volatile memory module 106.

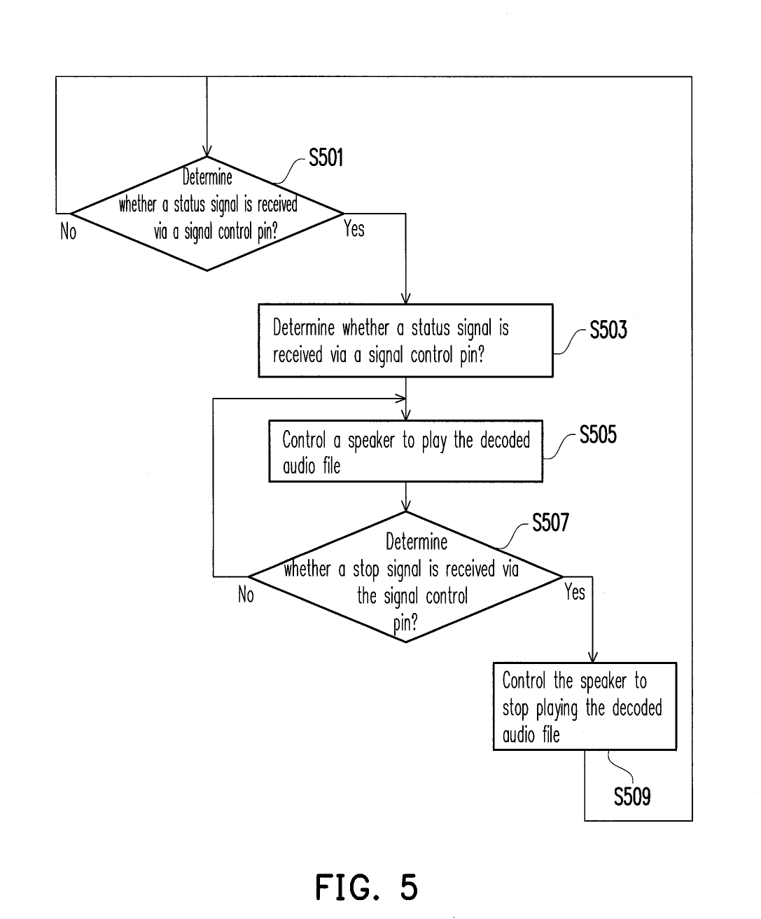

FIG. 5 is a flowchart of an audio playing method according to an exemplary embodiment of the present invention.

Referring to FIG. 5, after the memory storage apparatus 100 is coupled to the host system 1000, in step S501, the audio control circuit 402 determines whether a status signal is received via the signal control pin 120.

If no status signal is received, step S501 is execute to continuously detect whether the status signal is received.

If the status signal is received, in step S503, the audio control circuit 402 loads a corresponding audio file and decodes the loaded audio file.

Next, in step S505, the audio control circuit 402 controls the speaker 406 to play the decoded audio file.

After that, in step S507, the audio control circuit 402 determines whether a stop signal is received via the signal control pin 120.

If no stop signal is received, step S505 is executed to continuously or repeatedly play the audio file.

If the stop signal is received, in step S509, the audio control circuit 402 controls the speaker 406 to stop playing the decoded audio file, and after that, step S501 is executed.

As described above, in the present exemplary embodiment, when the memory management circuit 202 of the memory controller 104 executes a write command or a read command on the rewritable non-volatile memory module 106, the audio playing unit 108 plays the audio file until the write command or the read command is completed. Accordingly, the sound played by the audio playing unit 108 can effectively alert the user that data is being written into or read from the memory storage apparatus 100.

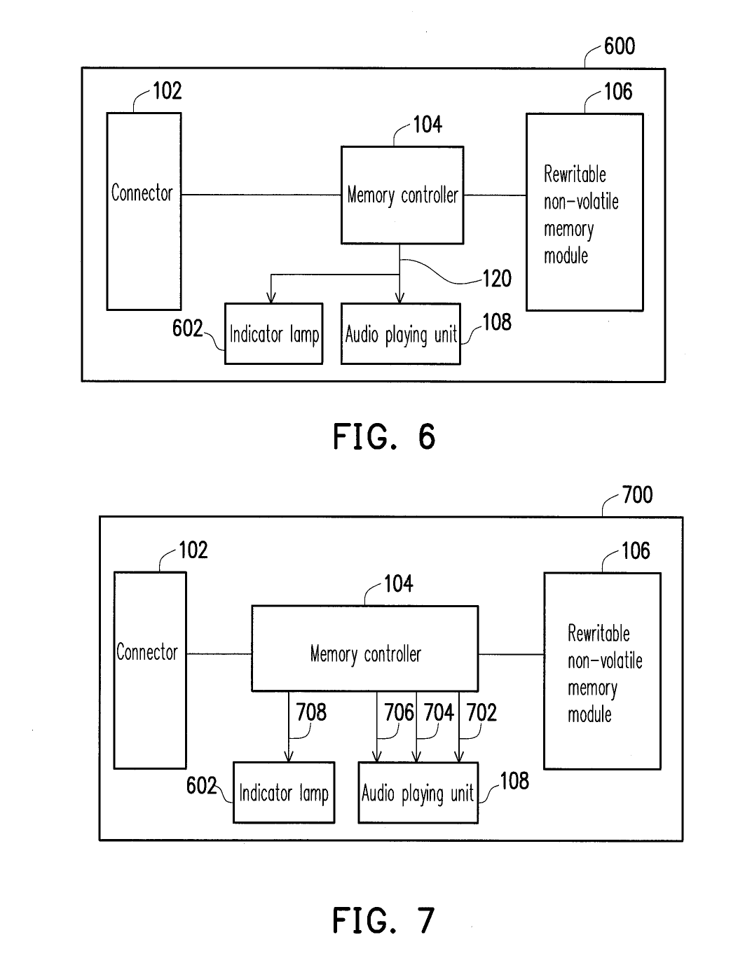

FIG. 6 is a schematic block diagram of a memory storage apparatus according to another exemplary embodiment of the present invention.

Referring to FIG. 6, the memory storage apparatus 600 includes a connector 102, a memory controller 104, a rewritable non-volatile memory module 106, an audio playing unit 108, and an indicator lamp 602.

The indicator lamp 602 is coupled to the memory controller 104 via a signal control pin 120. The indicator lamp 602 may be a light emitting diode (LED) lamp. In particular, the indicator lamp 602 continuously executes a flash operation according to a turn-on signal received from the memory controller 104 via the signal control pin 120 and stops the flash operation according to a stop signal received from the memory controller 104 via the signal control pin 120. Namely, in the present exemplary embodiment, the memory storage apparatus 100 alerts the user that data is being written into or read from the memory storage apparatus 100 through both sound and light signal.

It should be mentioned that in the present exemplary embodiment, the audio playing unit 108 identifies a data writing or reading operation according to a signal received via one signal control pin. However, the present invention is not limited thereto, and in another exemplary embodiment of the present invention, the memory controller 104 and the audio playing unit 108 may also be coupled with each other through multiple signal control pins.

FIG. 7 is a schematic block diagram of a memory storage apparatus according to another exemplary embodiment of the present invention.

Referring to FIG. 7, similarly, the memory storage apparatus 700 includes a connector 102, a memory controller 104, a rewritable non-volatile memory module 106, an audio playing unit 108, and an indicator lamp 602.

In the memory storage apparatus 700, the audio playing unit 108 receives signals from the memory controller 104 via a first signal control pin 702, a second signal control pin 704, and a third signal control pin 706. Besides, the indicator lamp 602 receives signals from the memory controller 104 via a fourth signal control pin 708. In particular, the audio playing unit 108 identifies different operations performed by the memory controller 104 according to signals received via multiple signal control pins and plays different types of sounds to indicate different access situations.

In summary, a memory storage apparatus, a memory controller, and an audio playing method are provided by the exemplary embodiments of the present invention, wherein an audio is played to alert a user when a memory storage apparatus is being accessed so that the user won't unplug the memory storage apparatus from a host system when the memory storage apparatus is being accessed. The previously described exemplary embodiments of the present invention have the advantages aforementioned, wherein the advantages aforementioned not required in all versions of the invention.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A memory storage apparatus, comprising:
a connector;
a rewritable non-volatile memory module;
a memory controller, coupled to the connector and the rewritable non-volatile memory module; and
an audio playing unit, coupled to the memory controller via at least one signal control pin, wherein the audio playing unit comprises:
a speaker; and
an audio control circuit, coupled to the speaker,
wherein the memory controller transmits at least one status information to the audio playing unit via the at least one signal control pin,
wherein the audio control circuit decodes at least one audio file according to the at least one status information and controls the speaker to play the decoded audio file.

2. The memory storage apparatus according to claim 1,
wherein the status information at least comprises an initial coupling status information, a read status information, a write status information, a rewritable non-volatile memory module good status information, or a rewritable non-volatile memory module bad status information,
wherein the audio file at least comprises at least one audio file corresponding to the initial coupling status information, at least one audio file corresponding to the read status information, at least one audio file corresponding to the write status information, at least one audio file corresponding to the rewritable non-volatile memory module good status information, or at least one audio file corresponding to the rewritable non-volatile memory module bad status information.

3. The memory storage apparatus according to claim 1,
wherein the memory controller transmits a stop signal to the audio playing unit via the signal control pin,
wherein the audio control circuit controls the speaker to stop playing the decoded audio file according to the stop signal.

4. The memory storage apparatus according to claim 1 further comprising an indicator lamp,
wherein the indicator lamp is coupled to the memory controller via the at least one signal control pin,
wherein the memory controller transmits a turn-on signal to the indicator lamp via the at least one signal control pin and the indicator lamp executes a flash operation according to the turn-on signal.

5. The memory storage apparatus according to claim 1 further comprising a indicator lamp,
wherein the indicator lamp is coupled to the memory controller via another signal control pin,
wherein the memory controller transmits a turn-on signal to the indicator lamp via the another signal control pin, and the indicator lamp executes a flash operation according to the turn-on signal.

6. The memory storage apparatus according to claim 1, wherein the audio playing unit further comprises a storage unit for storing the at least one audio file.

7. The memory storage apparatus according to claim 1, wherein the rewritable non-volatile memory module has a system area for storing the at least one audio file.

8. An audio playing method for a memory storage apparatus, wherein the memory storage apparatus has a rewritable non-volatile memory module and a speaker, the audio playing method comprising:
determining whether at least one status information is received; and
when the at least one status information is received, loading at least one audio file according to the at least one status information, decoding the at least one audio file, and controlling the speaker to play the decoded audio file,
wherein the at least one status information at least comprises an initial coupling status information, a read status information, a write status information, a rewritable non-volatile memory module good status information, or a rewritable non-volatile memory module bad status information,
wherein the at least one audio file at least comprises at least one audio file corresponding to the initial coupling status information, at least one audio file corresponding to the read status information, at least one audio file corresponding to the write status information, at least one audio file corresponding to the rewritable non-volatile memory module good status information, or at least one audio file corresponding to the rewritable non-volatile memory module bad status information.

9. The audio playing method according to claim 8 further comprising:
determining whether a stop signal is received; and
when the stop signal is received, controlling the speaker to stop playing the decoded audio file according to the stop signal.

10. A memory controller for accessing a rewritable non-volatile memory module according to instructions of a host system, the memory controller comprising:
a memory interface, configured to couple to the rewritable non-volatile memory module;
a host interface, configured to couple to the host system; and
a memory management circuit, coupled to the memory interface and the host interface,
wherein the memory management circuit transmits at least one status information to an audio playing unit with a speaker via at least one signal control pin, wherein the at least one status information allows the audio playing unit to decode at least one audio file and control the speaker to play the decoded audio file.

11. The memory controller according to claim 10,
wherein the memory management circuit transmits a stop signal via the signal control pin, and the stop signal allows the audio playing unit to control the speaker to stop playing the decoded audio file.

12. The memory controller according to claim 10,
wherein the at least one status information at least comprises an initial coupling status information, a read status information, a write status information, a rewritable non-volatile memory module good status information, or a rewritable non-volatile memory module bad status information,
wherein the at least one audio file at least comprises at least one audio file corresponding to the initial coupling status information, at least one audio file corresponding to the read status information, at least one audio file corresponding to the write status information, at least one audio file corresponding to the rewritable non-volatile memory module good status information, or at least one audio file corresponding to the rewritable non-volatile memory module bad status information.
